(19) United States
(12) Patent Application Publication
(10) Pub. No.: US 2022/0229757 A1
(43) Pub. Date: Jul. 21, 2022

(54) QUANTUM GATE BENCHMARKING METHOD AND APPARATUS, ELECTRONIC DEVICE, AND MEDIUM

(71) Applicant: BEIJING BAIDU NETCOM SCIENCE TECHNOLOGY CO., LTD., BEIJING (CN)

(72) Inventors: Yuao CHEN, BEIJING (CN); Shusen LIU, BEIJING (CN); Ningfeng WANG, BEIJING (CN)

(21) Appl. No.: 17/712,856

(22) Filed: Apr. 4, 2022

(30) Foreign Application Priority Data
Apr. 27, 2021 (CN) 202110462226.3

(51) Int. Cl. G06F 11/34; G06N 10/20

(52) U.S. Cl. CPC G06F 11/3428; G06N 10/20

(57) ABSTRACT

A method includes: obtaining a set of characterizing equations for a quantum gate to be benchmarked; in response to the set of characterizing equations including another quantum gate, determining whether the another quantum gate has been benchmarked as trusted; in response to the another quantum gate having been benchmarked as trusted, successively performing a quantum gate operation on each characterizing equation in the set of characterizing equations to obtain, for each characterizing equation, a corresponding measurement result; for each characterizing equation, determining whether the measurement result for the characterizing equation meets an expected result in the characterizing equation for characterization; and in response to the measurement results for each characterizing equation in the set of characterizing equations meeting the expected result, benchmarking the quantum gate to be benchmarked as trusted.

### CROSS REFERENCE TO RELATED APPLICATIONS

This application claims priority to Chinese Patent Application No. 202110462226.3, filed on Apr. 27, 2021, the contents of which are hereby incorporated by reference in their entirety for all purposes.

### TECHNICAL FIELD

The present disclosure relates to the quantum computing field, and in particular, to the field of quantum programming and quantum program testing technologies, and specifically, to a quantum gate benchmarking method and apparatus, an electronic device, a computer-readable storage medium, and a computer program product.

### BACKGROUND

A quantum circuit model is currently widely used in quantum computing, and the quantum circuit model can be abstracted into quantum gate circuits, measurement circuits, and qubits. In modern quantum computing platforms, most quantum gate circuits are composed of pulse instructions from a classical computer, and it is mainly logic instructions that correspond to the pulse instructions in a classical computer structure. Therefore, a whole process of quantum computing sequentially corresponds to classical computer's logic instructions, classical computer's pulse instructions, and quantum gate operations.

In a development process of a core program of a quantum computing platform and a production process of a quantum computer, whether all quantum gate operations are correctly implemented needs to be tested. After any quantum computer or quantum computing simulator is assembled and before it is put into use, correctness of all quantum gate operations needs to be tested, to eliminate errors in the foregoing various scenarios, for example, to eliminate errors that may be brought by tampering or environmental impact in an assembly process. However, there is often a lack of steps for testing correctness of quantum gate operations at present, resulting in errors and deviations in computation results even if a program can run.

### SUMMARY

The present disclosure provides a quantum gate benchmarking method and apparatus, an electronic device, a computer-readable storage medium, and a computer program product.

According to an aspect of the present disclosure, a quantum gate benchmarking method is provided, including: obtaining a set of characterizing equations for a quantum gate to be benchmarked; in response to the set of characterizing equations involving another quantum gate, determining whether the another quantum gate has been benchmarked as trusted; in response to the another quantum gate having been benchmarked as trusted, successively performing a quantum gate operation on each characterizing equation in the set of characterizing equations to obtain, for each characterizing equation, a corresponding measurement result; for each characterizing equation, determining whether the measurement result for the characterizing equation meets an expected result in the characterizing equation; and in response to the measurement results for each characterizing equation in the set of characterizing equations meeting the expected result, benchmarking the quantum gate to be benchmarked as trusted.

According to another aspect of the present disclosure, an electronic device is provided, including: one or more processors; and a memory storing one or more programs configured to be executed by the one or more processors, the one or more programs including instructions for causing the electronic device to perform operations comprising: obtaining a set of characterizing equations for a quantum gate to be benchmarked; in response to the set of characterizing equations involving another quantum gate, determining whether the another quantum gate has been benchmarked as trusted; in response to the another quantum gate having been benchmarked as trusted, successively performing a quantum gate operation on each characterizing equation in the set of characterizing equations to obtain, for each characterizing equation, a corresponding measurement result; for each characterizing equation, determining whether the measurement result for the characterizing equation meets an expected result in the characterizing equation; and in response to the measurement results for each characterizing equation in the set of characterizing equations meeting the expected result, benchmarking the quantum gate to be benchmarked as trusted.

According to another aspect of the present disclosure, a non-transitory computer-readable storage medium is provided, that stores one or more programs comprising instruction that, when executed by one or more processors of an electronic device, cause the electronic device to perform operations comprising: obtaining a set of characterizing equations for a quantum gate to be benchmarked; in response to the set of characterizing equations involving another quantum gate, determining whether the another quantum gate has been benchmarked as trusted; in response to the another quantum gate having been benchmarked as trusted, successively performing a quantum gate operation on each characterizing equation in the set of characterizing equations to obtain, for each characterizing equation, a corresponding measurement result; for each characterizing equation, determining whether the measurement result for the characterizing equation meets an expected result in the characterizing equation; and in response to the measurement results for each characterizing equation in the set of characterizing equations meeting the expected result, benchmarking the quantum gate to be benchmarked as trusted.

### BRIEF DESCRIPTION OF THE DRAWINGS

The drawings exemplarily show embodiments and form a part of the specification, and are used to explain exemplary implementations of the embodiments together with a written description of the specification. The embodiments shown are merely for illustrative purposes and do not limit the scope of the claims. Throughout the drawings, identical reference signs denote similar but not necessarily identical elements.

FIG. 1 is a flowchart of a method for benchmarking a quantum gate according to an embodiment of the present disclosure;

FIG. 2 is a flowchart of benchmarking a plurality of quantum gates according to an embodiment of the present disclosure;

FIG. 3 is a structural block diagram of an apparatus for benchmarking a quantum gate according to an embodiment of the present disclosure; and

FIG. 4 is a structural block diagram of an example electronic device that can be used to implement an embodiment of the present disclosure.

### DETAILED DESCRIPTION

Exemplary embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described herein, without departing from the scope of the present disclosure. Likewise, for clarity and simplicity, description of well-known functions and structures are omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, it may be one or more, unless otherwise expressly indicated in the context. Moreover, the term “and/or” used in the present disclosure encompasses any of and all possible combinations of listed items.

Embodiments of the present disclosure will be described below in detail in conjunction with the drawings.

A quantum gate operation is a core function of a quantum computer, and correct implementation of the quantum gate operation is a prerequisite for correct implementation of all quantum algorithms. To test correctness of a quantum gate operation, a usual method is to obtain a matrix representation of a quantum gate transformation in a group of bases of a quantum system through an experiment (such as process tomography), and to test correctness of the matrix for benchmarking to determine whether the quantum gate reaches an expected design. This usually requires a lot of experiments on a quantum computer to obtain enough statistical results for testing. Further, to improve accuracy, it usually requires an exponentially increasing number of experiments.

In addition, a lot of experiments are required, and some gates that are available also need to be learned a priori, that is, it needs to assume gates that can already be normally used. Consequently, a benchmarking result may have errors.

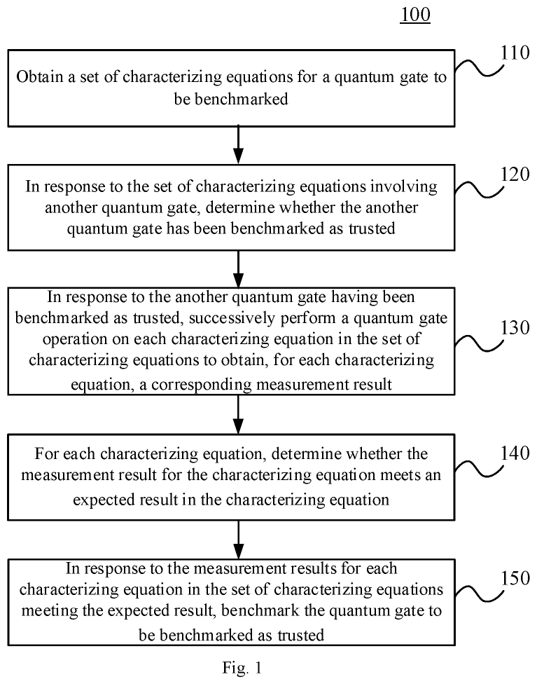

Therefore, according to an embodiment of the present disclosure, a method 100 for benchmarking a quantum gate is provided. As shown in FIG. 1, the method includes: obtaining a set of characterizing equations for a quantum gate to be benchmarked (step 110); in response to the set of characterizing equations involving another quantum gate, determining whether the another quantum gate has been benchmarked as trusted (step 120); in response to the another quantum gate having been benchmarked as trusted, successively performing a quantum gate operation on each characterizing equation in the set of characterizing equations to obtain, for each characterizing equation, a corresponding measurement result (step 130); for each characterizing equation, determining whether the measurement result for the characterizing equation meets an expected result in the characterizing equation (step 140); and in response to the measurement results for each characterizing equation in the set of characterizing equations meeting the expected result, benchmarking the quantum gate to be benchmarked as trusted (step 150).

According to this embodiment of the present disclosure, there is no need to assume that any gate has been benchmarked as trusted, and it only needs to test each characterizing equation in a set of characterizing equations in sequence, such that an amount of computation is reduced and benchmarking accuracy is also improved.

In some embodiments, the quantum gate to be benchmarked may include: a single-qubit quantum gate, a two-qubit quantum gate, and a three-qubit quantum gate.

For example, the single-qubit quantum gate may include: an identity gate ID, Pauli gates X, Y, and Z, a Hadamard gate H, a phase gate S^{†} and its reversal S′, and a π/8 gate T and its reversal T^{†}. The two-qubit quantum gate may include: controlled Pauli gates CX, CY, and CZ, a controlled Hadamard gate CH, and a Swap gate SWAP. The three-qubit quantum gate may include: a Toffoli gate CCX and a Fredkin gate CSWAP. The foregoing quantum gates can be used for almost all existing quantum computers.

In some embodiments, the set of characterizing equations is constructed based on a matrix representation of a unitary transformation.

A set of characterizing equations corresponding to one quantum gate includes several characterizing equations. The left side of an equal sign of each characterizing equation indicates that a series of quantum gates are applied to initial quantum states. The characterizing equations for the single-qubit quantum gate, the two-qubit quantum gate, and the three-qubit quantum gate correspond to a single-qubit circuit, a two-qubit circuit, and a three-qubit circuit, respectively. Correspondingly, the initial quantum states of the circuits are |0 [symbol] |00 [symbol] and |000 [symbol] , respectively. The equal sign indicates a process of applying a quantum gate. The right side of the equal sign is a determined quantum state, indicating a quantum state after the application. When a quantum state on the right side of the equal sign is |0 [symbol] , it indicates that a current observation result is |0 [symbol] . Similarly, when a quantum state on the right side of the equal sign is |101 [symbol] , it indicates that an observation result is |101 [symbol] (which corresponds to a case of a characterizing equation for the three-qubit quantum gate).

In particular, a quantum state on the right side of some characterizing equations for the single-qubit quantum gate is neither |0 [symbol] nor |1 [symbol] , but for example, α|0 [symbol] +β|1 [symbol] . Herein, α and β are complex numbers and meet |α|²+|β|²=1. In this case, a probability of an observation result being |0 [symbol] and a probability of an observation result being |1 [symbol] are |α|² and respectively. Selection of a characterizing equation needs to avoid using a quantum state other than |0 [symbol] and |1 [symbol] , that is, a superposition state.

Matrix representations of the quantum gates described above may be respectively as follows:

$$ID = [ \begin{matrix}1 & 0 \\ 0 & 1\end{matrix} ] , X = [ \begin{matrix}0 & 1 \\ 1 & 0\end{matrix} ] , Y = [ \begin{matrix}0 & - i \\ i & 0\end{matrix} ] , Z = [ \begin{matrix}1 & 0 \\ 0 & - 1\end{matrix} ] , H = \frac{1}{\sqrt{2}} [ \begin{matrix}1 & 1 \\ 1 & - 1\end{matrix} ] , S = [ \begin{matrix}1 & 0 \\ 0 & i\end{matrix} ] , {S}^{†} = [ \begin{matrix}1 & 0 \\ 0 & - i\end{matrix} ] , T = [ \begin{matrix}1 & 0 \\ 0 & {e}^{i π \text{/} 4}\end{matrix} ] , {T}^{†} = [ \begin{matrix}1 & 0 \\ 0 & {e}^{- i π \text{/} 4}\end{matrix} ] , CX = [ \begin{matrix}1 & 0 & 0 & 0 \\ 0 & 1 & 0 & 0 \\ 0 & 0 & 0 & 1 \\ 0 & 0 & 1 & 0\end{matrix} ] , CY = [ \begin{matrix}1 & 0 & 0 & 0 \\ 0 & 1 & 0 & 0 \\ 0 & 0 & 0 & - i \\ 0 & 0 & i & 0\end{matrix} ] , CZ = [ \begin{matrix}1 & 0 & 0 & 0 \\ 0 & 1 & 0 & 0 \\ 0 & 0 & 1 & 0 \\ 0 & 0 & 0 & - 1\end{matrix} ] , CH = [ \begin{matrix}1 & 0 & 0 & 0 \\ 0 & 1 & 0 & 0 \\ 0 & 0 & 1 \text{/} \sqrt{2} & 1 \text{/} \sqrt{2} \\ 0 & 0 & 1 \text{/} \sqrt{2} & - 1 \text{/} \sqrt{2}\end{matrix} ] , SWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] , CCX = [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 0 & 1 \\ 0 & 0 & 0 & 0 & 0 & 0 & 1 & 0\end{matrix} ] and CSWAP = [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 0 & 1 & 0 \\ 0 & 0 & 0 & 0 & 0 & 1 & 0 & 0 \\ 0 & 0 & 0 & 0 & 0 & 0 & 0 & 1\end{matrix} ] .$$

Herein, i=\sqrt{−1} is an imaginary unit.

In some embodiments, in a process of benchmarking the foregoing quantum gates, the following assumptions may be made: (1) A quantum computer on which testing is to be performed provides a group of standard orthogonal computing bases, |0 [symbol] or |1 [symbol] is returned after each measurement, and |0 [symbol] is definitely returned after measurement of |0 [symbol] . To be specific, a measurement module of a device for quantum gate benchmarking is ideal or can be ideal after errors are corrected or removed. (2) All quantum gates are assumed to be unitary transformations (unitary matrices), that is, impact of a noise is ignored. (3) Impact of a global phase on a measurement result is ignored. Since a global phase does not affect a measurement result, any information about the global phase cannot be obtained from the measurement result, and can be ignored.

On this basis, a set of characterizing equations for a unitary transformation is constructed based on a matrix representation of the unitary transformation according to the method of the present disclosure. To be specific, the unitary transformation meeting the equation set is unique in a sense of ignoring a global phase, and is a unitary transformation to be tested. Therefore, as long as a quantum computer tests a corresponding set of characterizing equations, it can be determined that the quantum computer can be trusted for implementation of such a unitary transformation.

The sets of characterizing equations for various common quantum gates are shown below successively. The sets of characterizing equations for quantum gates other than the Hadamard gate H include another quantum gate. Herein, the another quantum gate in each set of characterizing equations needs to have been benchmarked to be trusted in a prior benchmarking process. In other words, the another quantum gate has been benchmarked. Herein, “⋅” indicates a matrix product (or may be understood as a meaning that a quantum gate is used as a composition of unitary transformations); “⊗” indicates a tensor product operation of matrices (where different quantum gates are applied to qubits at corresponding locations at the same time); and “I” indicates that there is no quantum gate operation at a corresponding location, or may be understood as a meaning that an identity quantum gate ID is used.

The sets of characterizing equations for commonly-used single-qubit quantum gates are as follows:

The set of characterizing equations for H:

$$\{ \begin{matrix}H \vert 0 〉 = \frac{1}{\sqrt{2}} \vert 0 〉 + \frac{1}{\sqrt{2}} {e}^{i ϕ} \vert 1 〉 \\ H \cdot H \vert 0 〉 = \vert 0 〉 \end{matrix}$$

Herein, ϕ is a real parameter that does not need to be learned.

The set of characterizing equations for ID (dependent on H):

$$\{ \begin{matrix}ID \vert 0 〉 = \vert 0 〉 \\ H \cdot ID \cdot H \vert 0 〉 = \vert 0 〉\end{matrix}$$

The set of characterizing equations for X (dependent on H):

$$\{ \begin{matrix}X \vert 0 〉 = \vert 1 〉 \\ H \cdot X \cdot H \vert 0 〉 = \vert 0 〉\end{matrix}$$

The set of characterizing equations for Y (dependent on H):

$$\{ \begin{matrix}Y \vert 0 〉 = \vert 1 〉 \\ H \cdot Y \cdot H \vert 0 〉 = \vert 1 〉\end{matrix}$$

The set of characterizing equations for Z (dependent on H):

$$\{ \begin{matrix}Z \vert 0 〉 = \vert 0 〉 \\ H \cdot Z \cdot H \vert 0 〉 = \vert 1 〉\end{matrix}$$

The set of characterizing equations for S (dependent on H):

$$\{ \begin{matrix}S \vert 0 〉 = \vert 0 〉 \\ H \cdot S \cdot S \cdot H \vert 0 〉 = \vert 1 〉\end{matrix}$$

The set of characterizing equations for S^{†} (dependent on H and S):

$$\{ \begin{matrix}{S}^{†} \vert 0 〉 = \vert 0 〉 \\ H \cdot S \cdot {S}^{†} \cdot H \vert 0 〉 = \vert 0 〉\end{matrix}$$

The set of characterizing equations for T (dependent on H and S):

$$\{ \begin{matrix}T \vert 0 〉 = \vert 0 〉 \\ H \cdot T \cdot T \cdot S \cdot H \vert 0 〉 = \vert 1 〉 \\ H \cdot T \cdot H \vert 0 〉 = cos \frac{π}{8} \vert 0 〉 + sin \frac{π}{8} \vert 1 〉\end{matrix}$$

The set of characterizing equations for T^{†} (dependent on H and T):

$$\{ \begin{matrix}{T}^{†} \vert 0 〉 = \vert 0 〉 \\ H \cdot T \cdot {T}^{†} \cdot H \vert 0 〉 = \vert 0 〉\end{matrix}$$

The set of characterizing equations for commonly-used two-qubit quantum gates are as follows:

The set of characterizing equations for CX (dependent on H and X):

$$\{ \begin{matrix}CX \vert 00 〉 = \vert 00 〉 \\ CX \cdot ( I ⊗ X ) \vert 00 〉 = \vert 01 〉 \\ CX \cdot ( X ⊗ I ) \vert 00 〉 = \vert 11 〉 \\ CX \cdot ( X ⊗ X ) \vert 00 〉 = \vert 10 〉 \\ ( H ⊗ H ) \cdot CX \cdot ( H ⊗ H ) \vert 00 〉 = \vert 00 〉\end{matrix}$$

The set of characterizing equations for CY (dependent on H, X, and S):

$$\{ \begin{matrix}CY \vert 00 〉 = \vert 00 〉 \\ CY \cdot ( I ⊗ X ) \vert 00 〉 = \vert 01 〉 \\ CY \cdot ( X ⊗ I ) \vert 00 〉 = \vert 11 〉 \\ CY \cdot ( X ⊗ X ) \vert 00 〉 = \vert 10 〉 \\ ( H ⊗ ( H \cdot S ) ) \cdot CY \cdot ( H ⊗ ( S \cdot H ) ) \vert 00 〉 = \vert 01 〉\end{matrix}$$

The set of characterizing equations for CZ (dependent on H and X):

$$\{ \begin{matrix}CZ \vert 00 〉 = \vert 00 〉 \\ CZ \cdot ( I ⊗ X ) \vert 00 〉 = \vert 01 〉 \\ CZ \cdot ( X ⊗ I ) \vert 00 〉 = \vert 10 〉 \\ CZ \cdot ( X ⊗ X ) \vert 00 〉 = \vert 11 〉 \\ ( I ⊗ H ) \cdot CZ \cdot ( I ⊗ H ) \vert 00 〉 = \vert 00 〉 \\ ( H ⊗ I ) \cdot CZ \cdot ( H ⊗ I ) \vert 00 〉 = \vert 00 〉 \\ ( H ⊗ I ) \cdot CZ \cdot ( H ⊗ X ) \vert 00 〉 = \vert 11 〉\end{matrix}$$

The set of characterizing equations for CH (dependent on H, X, S, and T):

$$\{ \begin{matrix}CH \vert 00 〉 = \vert 00 〉 \\ CH \cdot ( I ⊗ X ) \vert 00 〉 = \vert 01 〉 \\ CH \cdot ( X ⊗ H ) \vert 00 〉 = \vert 10 〉 \\ CH \cdot ( X ⊗ ( H \cdot X ) ) \vert 00 〉 = \vert 11 〉 \\ CH \cdot CH \cdot ( X ⊗ I ) \vert 00 〉 = \vert 10 〉 \\ CH \cdot ( X ⊗ I ) \cdot CH \cdot ( I ⊗ H ) \vert 00 〉 = \vert 10 〉 \\ ( H ⊗ I ) \cdot CH \cdot CH \cdot ( H ⊗ I ) \vert 00 〉 = \vert 00 〉 \\ ( H ⊗ ( S \cdot H \cdot T \cdot H \cdot S ) ) \cdot CH \cdot ( H ⊗ ( S \cdot H \cdot T \cdot H \cdot S ) ) \vert 00 〉 = \vert 00 〉\end{matrix}$$

The set of characterizing equations for SWAP (dependent on H and X):

$$\{ \begin{matrix}SWAP \vert 00 〉 = \vert 00 〉 \\ SWAP ( I ⊗ X ) \vert 00 〉 = \vert 10 〉 \\ SWAP ( X ⊗ I ) \vert 00 〉 = \vert 01 〉 \\ SWAP ( X ⊗ X ) \vert 00 〉 = \vert 11 〉 \\ ( H ⊗ H ) \cdot SWAP \cdot ( H ⊗ H ) \vert 00 〉 = \vert 00 〉\end{matrix}$$

The sets of characterizing equations for commonly-used three-qubit quantum gates are as follows:

The set of characterizing equations for CCX (dependent on H and X):

$$\{ \begin{matrix}CCX \vert 000 〉 = \vert 000 〉 \\ CCX \cdot ( I ⊗ I ⊗ X ) \vert 000 〉 = \vert 001 〉 \\ CCX \cdot ( I ⊗ X ⊗ I ) \vert 000 〉 = \vert 010 〉 \\ CCX \cdot ( I ⊗ X ⊗ X ) \vert 000 〉 = \vert 011 〉 \\ CCX \cdot ( X ⊗ I ⊗ I ) \vert 000 〉 = \vert 100 〉 \\ CCX \cdot ( X ⊗ I ⊗ X ) \vert 000 〉 = \vert 101 〉 \\ CCX \cdot ( X ⊗ X ⊗ I ) \vert 000 〉 = \vert 111 〉 \\ CCX \cdot ( X ⊗ X ⊗ X ) \vert 000 〉 = \vert 110 〉 \\ ( H ⊗ H ⊗ H ) \cdot CCX \cdot ( H ⊗ H ⊗ H ) \vert 000 〉 = \vert 000 〉\end{matrix}$$

The set of characterizing equations for CSWAP (dependent on H and X):

$$\{ \begin{matrix}C SWAP \vert 000 〉 = \vert 000 〉 \\ C SWAP \cdot ( I ⊗ I ⊗ X ) \vert 000 〉 = \vert 001 〉 \\ C SWAP \cdot ( I ⊗ X ⊗ I ) \vert 000 〉 = \vert 010 〉 \\ C SWAP \cdot ( I ⊗ X ⊗ X ) \vert 000 〉 = \vert 011 〉 \\ C SWAP \cdot ( X ⊗ I ⊗ I ) \vert 000 〉 = \vert 100 〉 \\ C SWAP \cdot ( X ⊗ I ⊗ X ) \vert 000 〉 = \vert 110 〉 \\ C SWAP \cdot ( X ⊗ X ⊗ I ) \vert 000 〉 = \vert 101 〉 \\ C SWAP \cdot ( X ⊗ X ⊗ X ) \vert 000 〉 = \vert 111 〉 \\ ( H ⊗ H ⊗ H ) \cdot C SWAP \cdot ( H ⊗ H ⊗ H ) \vert 000 〉 = \vert 000 〉\end{matrix}$$

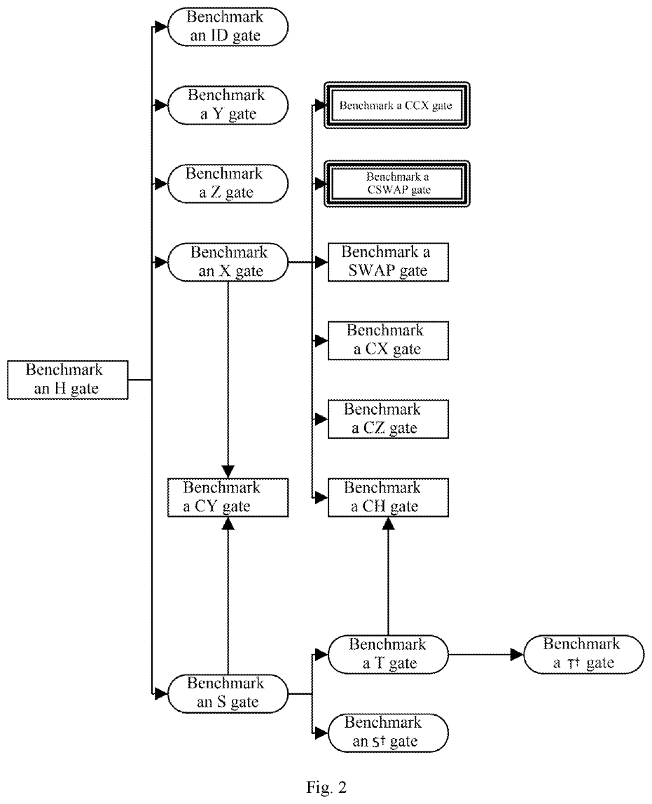

FIG. 2 is a flowchart of benchmarking a plurality of quantum gates. As shown in FIG. 2, benchmarking of each quantum gate requires a prerequisite that a quantum gate indicated by an end of an arrow associated with the foregoing quantum gate has been benchmarked to be trusted. To be specific, benchmarking of each quantum gate requires a prerequisite that benchmarking of a quantum gate on which the foregoing quantum gate is dependent is completed. For example, to benchmark the quantum gate SWAP, benchmarking of the quantum gates H and X needs to be completed.

Compared with the process tomography, the method according to the present disclosure does not require an assumption of any quantum gate having been benchmarked to be trusted, but only requires quantum gate benchmarking to be performed successively according to the process shown in FIG. 2.

In some embodiments, the successively performing quantum gate operations based on each characterizing equation in the set of characterizing equations, to obtain a corresponding measurement result includes: in response to expected results corresponding to one or more characterizing equations being in a superposition state, separately performing quantum gate operation a plurality of times based on each characterizing equation in the one or more characterizing equations, to obtain a plurality of corresponding measurement results; and for each characterizing equation: collecting statistics about the number of times the plurality of corresponding measurement results are in a corresponding state in the superposition state.

In some examples, for example, for the set of characterizing equations described above, in a process of each quantum gate operation, corresponding quantum gates are applied successively to initialized quantum states based on corresponding characterizing equations, to obtain a quantum state after the application. The quantum state after the application may be measured, to obtain a corresponding measurement result.

Therefore, in some embodiments, the method according to the present disclosure may further include a step for initializing a corresponding qubit, thereby obtaining a quantum state to be measured is obtained by performing quantum gate operations on the initialized qubit.

According to some embodiments, the determining whether the measurement result meets an expected result in the corresponding characterizing equation includes: determining, based on a hypothesis testing method, whether the measurement results corresponding to the one or more characterizing equations meet the expected results.

Herein, although a plurality of quantum gate operations are required to obtain a plurality of measurement results, it is far less than the number of repetitions in another method such as the process tomography, also greatly reduces an amount of computation, and improves benchmarking efficiency.

In some examples, H is used as an example for describing a process of determining, based on the hypothesis testing method, whether the measurement results meet the expected results. The set of characterizing equations of H is shown above:

$$\{ \begin{matrix}H \vert 0 〉 = \frac{1}{\sqrt{2}} \vert 0 〉 + \frac{1}{\sqrt{2}} {e}^{i ϕ} \vert 1 〉 \\ H \cdot H \vert 0 〉 = \vert 0 〉\end{matrix}$$

Herein, ϕ is a real parameter that does not need to be learned.

It can be proved that if H is a unitary matrix meeting the foregoing set of characterizing equations, H may be simplified by using a method of undetermined coefficients as:

$$H = \frac{1}{\sqrt{2}} [ \begin{matrix}1 & {e}^{- i ϕ} \\ {e}^{i ϕ} & - 1\end{matrix} ]$$

Therefore, a matrix representation of the unitary transformation H in a new group of bases {|0 [symbol] , e^{iϕ}|1 [symbol] } is as follows:

$$H = \frac{1}{\sqrt{2}} [ \begin{matrix}1 & 1 \\ 1 & - 1\end{matrix} ]$$

This is exactly a usual matrix form of a Hadamard gate. Therefore, after a global phase is ignored, as long as it is verified that a unitary transformation H meets H|0 [symbol] is an equal-amplitude superposition state of |0 [symbol] and |1 [symbol] , H can be considered as a Hadamard gate.

In some embodiments, the hypothesis testing method may be used to verify whether H|0 [symbol] is an equal-amplitude superposition state of |0 [symbol] and |1 [symbol] , and the characterizing equation for H|0 [symbol] is:

$$H \vert 0 〉 = \frac{1}{\sqrt{2}} \vert 0 〉 + \frac{1}{\sqrt{2}} {e}^{i ϕ} \vert 1 〉$$

An original assumption is that “H|0 [symbol] is an equal-amplitude superposition state of |0 [symbol] and |1 [symbol] ”, and then the quantum state H|0 [symbol] is repeatedly made and measured N times. The counting shows that |0 [symbol] appears t times, and a probability that H is considered as not meeting expectations is P_{H}(t):

$${P}_{H} ( t ) = 1 - \frac{2}{{2}^{N}} {\sum }_{j = 0}^{min \{ t , N - t \}} ( \begin{matrix}N \\ j\end{matrix} )$$

When N=1000, a relationship between t and P_{H}(t) is shown in Table 1:

TABLE 1

| | | | | | |
|---|---|---|---|---|---|
| t | 439 | 448 | 459 | 469 | 474 |
| t | 561 | 552 | 541 | 531 | 526 |
| P_{T} (t) | 99.99% | 99.9% | 99% | 95% | 90% |

For example, a probability below 90% of not meeting expectations is generally considered acceptable, so that as long as 474<t<526, H can be considered as meeting expectations, and the foregoing characterizing equation has been benchmarked to be trusted.

That the quantum state H|0 [symbol] is repeatedly made and measured N times indicates performing of the following operation N times: initializing the single-qubit state |0 [symbol] , applying an unbenchmarked quantum gate H to the initialized single-qubit state |0 [symbol] to obtain the quantum state H|0 [symbol] , and measuring the obtained quantum state H|0 [symbol] to obtain a measurement result.

In some embodiments, T is used as an example for describing a process of benchmarking a quantum gate. The set of characterizing equations for T (dependent on H and S) is shown above:

$$\{ \begin{matrix}T \vert 0 〉 = \vert 0 〉 \\ H \cdot T \cdot T \cdot S \cdot H \vert 0 〉 = \vert 1 〉 \\ H \cdot T \cdot H \vert 0 〉 = cos \frac{π}{8} \vert 0 〉 + sin \frac{π}{8} \vert 1 〉\end{matrix}$$

The characterizing Equations T|0 [symbol] =|0 [symbol] , H·T·T·S·H|0 [symbol] =|1 [symbol] , and

$$H \cdot T \cdot H \vert 0 〉 = cos \frac{π}{8} \vert 0 〉 + sin \frac{π}{8} \vert 1 〉$$

are verified successively in an order in the set of characterizing equations.

As for the equation T|0 [symbol] =|0 [symbol] , an unbenchmarked quantum gate T is applied to the initialized single-qubit state |0 [symbol] to obtain and then observe an unknown quantum state T|0 [symbol] . If an observation result is not |0 [symbol] , a failure has been benchmarked, that is, the quantum gate T operation does not meet expectations; or if an observation result is |0 [symbol] , the equation T|0 [symbol] =|0 [symbol] has been benchmarked with success. Then, the equation H·T·T·S·H|0 [symbol] =|1 [symbol] is further benchmarked.

As for the equation H·T·T·S·H|0 [symbol] =|1 [symbol] , similarly, benchmarked quantum gates H and S are successively applied to the initialized single-qubit state |0 [symbol] , then the unbenchmarked quantum gate T is applied twice, and further the benchmarked quantum gate H is applied, to obtain and then observe an unknown quantum state H·T·T·S·H|0 [symbol] . If an observation result is not |1 [symbol] , a failure has been benchmarked, that is, the quantum gate T operation does not meet expectations; or if an observation result is |1 [symbol] , the equation H·T·T·S·H|0 [symbol] |1 [symbol] has been benchmarked with success. Then, the equation

$$H \cdot T \cdot H \vert 0 〉 = cos \frac{π}{8} \vert 0 〉 + sin \frac{π}{8} \vert 1 〉$$

is further benchmarked.

As for the equation

$$H \cdot T \cdot H \vert 0 〉 = cos \frac{π}{8} \vert 0 〉 + sin \frac{π}{8} \vert 1 〉$$

whether observation results of the equation meets expectations is determined by using the hypothesis testing method. An original assumption is that “an amplitude in a direction of |0 [symbol] in the quantum state H·T·H|0 [symbol] is greater than an amplitude in a direction of |1 [symbol] ”, and the quantum state H·T·H|0 [symbol] is repeatedly made and measured N times. The counting shows that |0 [symbol] appears t times, and a probability that T is considered as not meeting expectations is P_{T}(t):

$${P}_{H} ( t ) = 1 - \frac{2}{{2}^{N}} {\sum }_{j = 0}^{t} ( \begin{matrix}N \\ j\end{matrix} )$$

When N=1000, a relationship between t and P_{T}(t) is shown in Table 2:

TABLE 2

| | | | | | |
|---|---|---|---|---|---|
| t | 432 | 441 | 463 | 474 | 479 |
| P_{T} (t) | 99.99% | 99.9% | 99% | 95% | 90% |

When a probability below 90% of not meeting expectations is considered acceptable, as long as t >479, T can be considered as meeting expectations (which means the original assumption is true), and the characterizing equation

$$H \cdot T \cdot H \vert 0 〉 = cos \frac{π}{8} \vert 0 〉 + sin \frac{π}{8} \vert 1 〉$$

has been benchmarked with success.

When the three characterizing equations in the set of characterizing equations for T are all benchmarked with success, the quantum gate is considered as being benchmarked with success, that is, the quantum gate T is trusted.

According to any embodiment of the present disclosure, trustworthiness of a core quantum operation is tested fast and comprehensively; a solution of one-time system verification is provided based on dependency relationship between different quantum gates, thereby avoiding testing of each gate by using the same method; and a specific operation is tested based on characterization of each gate, to avoid all-round measurement of the quantum gate, thereby reducing an amount of computation and improving benchmarking efficiency.

According to some embodiments, the method may further include: in response to there being a deviation between the measurement results corresponding to the one or more characterizing equations in the set of characterizing equations and the expected results, determining fidelity of the quantum gate to be benchmarked based on the deviation.

When a noise of a quantum computer cannot be ignored, the quantum gate benchmarking method according to the present disclosure can be used for benchmarking a degree to which a quantum gate operation is affected by the noise. In other words, fidelity of a quantum gate can further be measured based on an characterizing equation, to infer fidelity of a unitary transformation based on trustworthiness of an output state. Because an characterizing equation is unique, any imperfect implementation of a unitary transformation may be reflected by a deviation of an output state on the right side of an equal sign of the characterizing equation, which can give a measurement of fidelity of a quantum gate. This measurement criterion may further be compared with measurement with several common types of norms, to provide an estimation of an error norm of a quantum gate based on a degree of deviation of an output state.

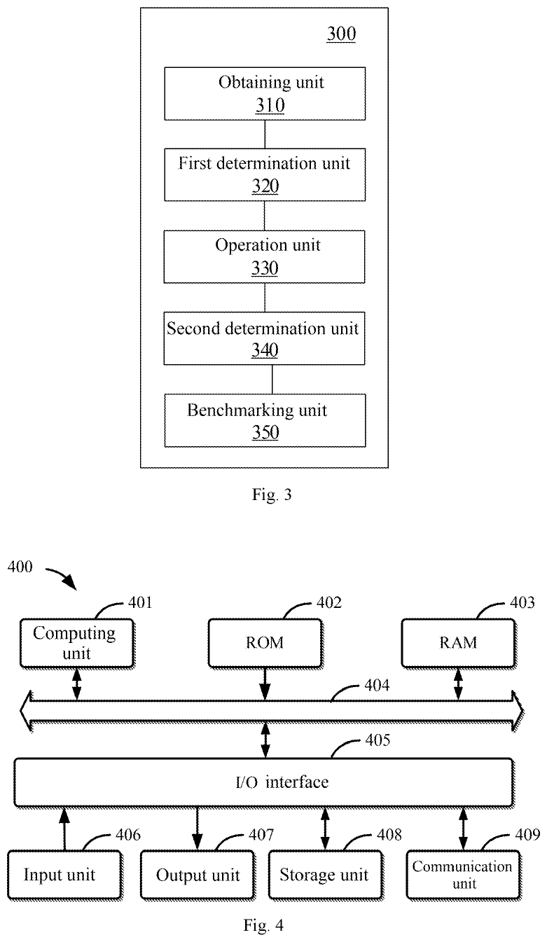

According to an embodiment of the present disclosure, a quantum gate benchmarking apparatus 300 is further provided. As shown in FIG. 3, the apparatus includes: an obtaining unit 310 configured to obtain an set of characterizing equations for a quantum gate to be benchmarked; a first determination unit 320 configured to: in response to the set of characterizing equations including another quantum gate, determine whether the another quantum gate has been benchmarked as trusted; an operation unit 330 configured to: in response to the another quantum gate having been benchmarked to be trusted, successively perform quantum gate operations based on each characterizing equation in the set of characterizing equations, to obtain a corresponding measurement result; a second determination unit 340 configured to determine whether the measurement result meets an expected result in the corresponding characterizing equation; and a benchmarking unit 350 configured to: in response to the measurement result corresponding to each characterizing equation in the set of characterizing equations meeting the expected result, benchmark the quantum gate to be benchmarked as trusted.

In some embodiments, the apparatus for benchmarking quantum gate may be, for example, a quantum computer, a quantum computing simulator, or the like. This is not limited herein.

Herein, the operations of the foregoing units 310 to 350 of the apparatus 300 for benchmarking quantum gate are respectively similar to the operations in steps 110 to 150 described above. Details are not provided herein again.

According to an exemplary embodiment of the present disclosure, an electronic device is further provided, including: at least one processor; and a memory communicatively connected to the at least one processor, where the memory stores instructions executable by the at least one processor, and when executed by the at least one processor, the instructions cause the at least one processor to perform the quantum gate benchmarking method described above.

According to an exemplary embodiment of the present disclosure, a non-transitory computer-readable storage medium storing computer instructions is further provided, where the computer instructions are used to cause the computer to perform the quantum gate benchmarking method described above.

According to an exemplary embodiment of the present disclosure, a computer program product is further provided, where the computer program product includes a computer program, and when the computer program is executed by a processor, the quantum gate benchmarking method described above is implemented.

Referring to FIG. 4, a structural block diagram of an electronic device 400 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 4, the device 400 includes a computing unit 401, which may perform various appropriate actions and processing according to a computer program stored in a read-only memory (ROM) 402 or a computer program loaded from a storage unit 408 to a random access memory (RAM) 403. The RAM 403 may further store various programs and data required for the operation of the device 400. The computing unit 401, the ROM 402, and the RAM 403 are connected to each other through a bus 404. An input/output (I/O) interface 405 is also connected to the bus 404.

A plurality of components in the device 400 are connected to the I/O interface 405, including: an input unit 406, an output unit 407, the storage unit 408, and a communication unit 409. The input unit 406 may be any type of device capable of entering information to the device 400. The input unit 406 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 407 may be any type of device capable of presenting information, and may include, but is not limited to, a display, a speaker, a video/audio output terminal, a vibrator, and/or a printer. The storage unit 408 may include, but is not limited to, a magnetic disk and an optical disc. The communication unit 409 allows the device 400 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 802.11 device, a Wi-Fi device, a WiMAX device, a cellular communication device and/or the like.

The computing unit 401 may be various general-purpose and/or special-purpose processing components with processing and computing capabilities. Some examples of the computing unit 401 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 401 performs the various methods and processing described above, for example, the method 100. For example, in some embodiments, the method 100 may be implemented as a computer software program, which is tangibly contained in a machine-readable medium, such as the storage unit 408. In some embodiments, a part or all of the computer program may be loaded and/or installed onto the device 400 via the ROM 402 and/or the communication unit 409. When the computer program is loaded onto the RAM 403 and executed by the computing unit 401, one or more steps of the method 100 described above can be performed. Alternatively, in other embodiments, the computing unit 401 may be configured, by any other suitable means (for example, by means of firmware), to perform the method 100.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: the systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, voice input, or tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other.

It should be understood that steps may be reordered, added, or deleted based on the various forms of procedures shown above. For example, the steps recorded in the present disclosure can be performed in parallel, in order, or in a different order, provided that the desired result of the technical solutions disclosed in the present disclosure can be achieved, which is not limited herein.

Although the embodiments or examples of the present disclosure have been described with reference to the drawings, it should be understood that the methods, systems, and devices described above are merely exemplary embodiments or examples, and the scope of the present disclosure is not limited by the embodiments or examples, and is only defined by the scope of the granted claims and the equivalents thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A method for benchmarking a quantum gate, the method comprising:
obtaining a set of characterizing equations for a quantum gate to be benchmarked;
in response to the set of characterizing equations involving another quantum gate, determining whether the another quantum gate has been benchmarked as trusted;
in response to the another quantum gate having been benchmarked as trusted, successively performing a quantum gate operation on each characterizing equation in the set of characterizing equations to obtain, for each characterizing equation, a corresponding measurement result;
for each characterizing equation, determining whether the measurement result for the characterizing equation meets an expected result in the characterizing equation; and
in response to the measurement results for each characterizing equation in the set of characterizing equations meeting the expected result, benchmarking the quantum gate to be benchmarked as trusted.

2. The method according to claim 1, wherein the quantum gate to be benchmarked comprises at least one of the following:
a single-qubit quantum gate, a two-qubit quantum gate, or a three-qubit quantum gate.

3. The method according to claim 1, wherein the set of characterizing equations is constructed based on a matrix representation of a unitary transformation.

4. The method according to claim 1, wherein the successively performing the quantum gate operations on each characterizing equation in the set of characterizing equations comprises:
in response to the expected result in one or more characterizing equations being in a superposition state, respectively performing quantum gate operations a plurality of times based on each of the one or more characterizing equations, to obtain a plurality of measurement results respectively corresponding to each of the one or more characterizing equations; and
for each of the one or more characterizing equations: collecting statistics about a number of times the plurality of measurement results are in a corresponding state in the superposition state.

5. The method according to claim 4, wherein, for a first characterizing equation, determining whether a first measurement result for the first characterizing equation meets a first expected result in the first characterizing equation comprises:
determining, based on a hypothesis testing method, whether the first measurement result meets the first expected result.

6. The method according to claim 1, further comprising:
in response to there being a deviation between a measurement result corresponding to a one or more characterizing equations in the set of characterizing equations and a corresponding expected result, determining a fidelity of the quantum gate to be benchmarked based on the deviation.

7. An electronic device, comprising:
one or more processors; and
a memory storing one or more programs configured to be executed by the one or more processors, the one or more programs including instructions for causing the electronic device to perform operations comprising:
obtaining a set of characterizing equations for a quantum gate to be benchmarked;
in response to the set of characterizing equations involving another quantum gate, determining whether the another quantum gate has been benchmarked as trusted;
in response to the another quantum gate having been benchmarked as trusted, successively performing a quantum gate operation on each characterizing equation in the set of characterizing equations to obtain, for each characterizing equation, a corresponding measurement result;
for each characterizing equation, determining whether the measurement result for the characterizing equation meets an expected result in the characterizing equation; and
in response to the measurement results for each characterizing equation in the set of characterizing equations meeting the expected result, benchmarking the quantum gate to be benchmarked as trusted.

8. The electronic device according to claim 7, wherein the quantum gate to be benchmarked comprises at least one of the following:
a single-qubit quantum gate, a two-qubit quantum gate, or a three-qubit quantum gate.

9. The electronic device according to claim 7, wherein the set of characterizing equations is constructed based on a matrix representation of a unitary transformation.

10. The electronic device according to claim 7, wherein the successively performing the quantum gate operations on each characterizing equation in the set of characterizing equations comprises:
in response to the expected result in one or more characterizing equations being in a superposition state, respectively performing quantum gate operations a plurality of times based on each of the one or more characterizing equations, to obtain a plurality of measurement results respectively corresponding to each of the one or more characterizing equations; and
for each of the one or more characterizing equations: collecting statistics about a number of times the plurality of measurement results are in a corresponding state in the superposition state.

11. The electronic device according to claim 10, wherein, for a first characterizing equation, determining whether a first measurement result for the first characterizing equation meets a first expected result in the first characterizing equation comprises:
determining, based on a hypothesis testing method, whether the first measurement result meets the first expected result.

12. The electronic device according to claim 7, the operations further comprising:
in response to there being a deviation between a measurement result corresponding to one or more characterizing equations in the set of characterizing equations and a corresponding expected result, determining a fidelity of the quantum gate to be benchmarked based on the deviation.

13. A non-transitory computer-readable storage medium that stores one or more programs comprising instructions that, when executed by one or more processors of an electronic device, cause the electronic device to perform operations comprising:
obtaining a set of characterizing equations for a quantum gate to be benchmarked;
in response to the set of characterizing equations involving another quantum gate, determining whether the another quantum gate has been benchmarked as trusted;
in response to the another quantum gate having been benchmarked as trusted, successively performing a quantum gate operation on each characterizing equation in the set of characterizing equations to obtain, for each characterizing equation, a corresponding measurement result;
for each characterizing equation, determining whether the measurement result for the characterizing equation meets an expected result in the characterizing equation; and
in response to the measurement results for each characterizing equation in the set of characterizing equations meeting the expected result, benchmarking the quantum gate to be benchmarked as trusted.

14. The non-transitory computer-readable storage medium according to claim 13, wherein the quantum gate to be benchmarked comprises at least one of the following:
a single-qubit quantum gate, a two-qubit quantum gate, or a three-qubit quantum gate.

15. The non-transitory computer-readable storage medium according to claim 13, wherein the set of characterizing equations is constructed based on a matrix representation of a unitary transformation.

16. The non-transitory computer-readable storage medium according to claim 13, wherein the successively performing the quantum gate operations on each characterizing equation in the set of characterizing equations comprises:
in response to the expected result in one or more characterizing equations being in a superposition state, respectively performing quantum gate operations a plurality of times based on each of the one or more characterizing equations, to obtain a plurality of measurement results respectively corresponding to each of the one or more characterizing equations; and
for each of the one or more characterizing equations: collecting statistics about a number of times the plurality of measurement results are in a corresponding state in the superposition state.

17. The non-transitory computer-readable storage medium according to claim 16, wherein, for a first characterizing equation, determining whether a first measurement result for the first characterizing equation meets a first expected result in the first characterizing equation comprises:
determining, based on a hypothesis testing method, whether the first measurement result meets the first expected result.

18. The non-transitory computer-readable storage medium according to claim 13, the operations further comprising:
in response to there being a deviation between a measurement result corresponding to one or more characterizing equations in the set of characterizing equations and a corresponding expected result, determining a fidelity of the quantum gate to be benchmarked based on the deviation.
